(19) United States
(12) Patent Application Publication
(10) Pub. No.: US 2026/0086023 A1
(43) Pub. Date: Mar. 26, 2026

(54) DEVICE FOR OPTICAL CALIBRATION OF ROTARY ANALYTICAL INSTRUMENT

(71) Applicant: LaMotte Chemical Products Company, Chestertown, MD (US)

(72) Inventor: James W. Egan, JR., Lynch, MD (US)

(73) Assignee: LaMotte Chemical Products Company, Chestertown, MD (US)

(21) Appl. No.: 18/892,689

(22) Filed: Sep. 23, 2024

(51) Int. Cl. G01N 21/31

(52) U.S. Cl. CPC G01N 21/31; G01N 2201/127

(57) ABSTRACT

A calibration disk for a rotary analytical device. The calibration disk includes a main portion with top and bottom surfaces and a central rotational axis. A cylindrical extrusion extends upward from the top surface. The main portion substantially surrounds the cylindrical extrusion and includes a flat planar portion that extends radially outward from the cylindrical extrusion. The cylindrical extrusion has a top surface and a sidewall surrounding an open interior cavity. A central opening in the top surface provides access to the interior cavity. A plurality of attenuation zones are formed in the body and spaced around the cylindrical extrusion. Some of the attenuation zones include at least one aperture extending through the body from the top surface to the bottom surface. The apertures are located at a common radial position about the central axis. At least two of the apertures have a different radial width or axial length.

### FIELD OF THE INVENTION

The invention relates to rotary optical analytical measuring instruments and, more particularly, to a device and method for optically calibrating a rotary optical analytical measuring instrument.

### BACKGROUND

It is frequently desired to analyze a liquid sample to determine the presence and concentration of analytes such as treatment chemicals and/or contaminants. In many instances, testing for multiple different analytes may be desired from a single liquid sample. For example, swimming-pool water is commonly tested for chlorine, pH, alkalinity, hardness, copper, and iron. Other businesses and industries where the desired technology is applicable include brewing, aquaculture, drinking water, wastewater, boiler/cooler water, and environmental monitoring.

In the prior art, methods and apparatus for determining such a presence and concentration of analytes are well known. Using the method of spectrophotometry, a liquid sample can be tested for an analyte by mixing the liquid sample with a photometric reagent for the desired analyte. Reagents are available to provide an almost instantaneous result by changing either the hue or intensity of color in response to a specific analyte in the liquid. When a light source is directed at the solution, the solution will absorb and transmit light over a certain range of wavelengths depending on the analyte concentration. Photodetectors, located on the opposite side of the solution from the light source, detect the intensity of light transmitted through the resulting solution, which may be used to determine the concentration of an analyte.

To accurately determine analyte concentration, there is a need to perform an optical calibration to verify the measurements of the photometer. There are several methods of photometric calibration that are known. In one method, a plurality of known analyte concentrations may be used to correct the measured absorbance of light in a photometer. Second, a plurality of grey films, with increasingly darker shades of grey, may be used to correct the measured absorbance of light in a photometer. In each method, photometric measurements may be taken to determine light transmittance and to calculate light absorbance for each trial. Any variation from the expected transmittance of light that is measured by the photometer may be used for calibration by means of mathematical corrections.

A rotary analytical device such as disclosed in U.S. Pat. No. 8,734,734 B2, which is incorporated herein by reference in its entirety, is so constructed to test a liquid sample of different properties, such as detecting the presence or absence of several different analytes, in a single operation, and to obtain the results of the tests automatically without relying on human judgment. That device may have a housing with a cavity formed therein. The cavity may be defined by a bottom wall, and at least one side wall. A spindle may protrude upward into the cavity and rotate about an axis by means of a motor. The spindle is designed to receive and rotate an analytical reagent cartridge. The cartridge may have a housing, an axis, analysis chambers spaced from and located circumferentially about the axis and that contain photometric reagents, and a magnetically movable element located in and movable within each analysis chamber to mix fluid in the analysis chambers. The housing may also include at least one light source arranged to direct a beam of light through an analysis chamber of a cartridge and be received by at least one light sensor or photometer. The photometer is sensitive to the color (wavelength) emitted by the light source; thus, the concentration of at least one constituent may be determined as the cartridge rotates causing each of the analysis chambers to pass between the light source and the photometer.

To measure absorbance, a calibration disk assembly consisting of a disk cover, analytical cartridge, and a series of grey film filters may be mounted onto the device's spindle. Photometric measurements may be taken dynamically, in a similar nature as normal operation, and the measurement of the light passing through the film allows for the calculation of absorbance. The absorbance values may be compared to match the expected absorbance or scattering of light known from the given shades of grey film, thus permitting calibration of the device. However, such a configuration is expensive, difficult for manufacturers to assemble, and introduces variations in every film leading to decreased performance.

In an ideal situation, once the calibration is set for a given photometer, no additional corrections will be needed. However, every photometer varies slightly due to variations in its optical construction, thereby potentially necessitating different corrections for each photometer. Also, incorrect or absent rotary calibration may affect the readings taken on a photometer, introducing non-ideal optical conditions. Light source intensity and photometer sensitivity can also change over time, thus requiring end user adjustments to the calibrated correction.

A major cause of meter error is incorrect rotary calibration. The reagent wells must be collinear with the measurement light source and photodetector. This collinearity may be accomplished by a calibration technique in which a known point on the reagent disk is correlated to a known point within the meter. This essentially locates the reagent wells to the meter motor spindle, such that the light transmission readings are taken directly through the wells.

As noted above, there can be changes to the intensities of the measurement LEDs over time. Inherent factors, such as LED age, and environmental factors, such as ambient temperature, can create LED intensity variations.

There is, therefore, a need for an improved method of performing a dynamic optical calibration of a multi-wavelength rotary photometer, such as disclosed in U.S. Pat. No. 8,734,734 B2, to mathematically correct the reading of an uncalibrated photometer to adjust for variations or changes in light sources, photodetectors, alignment of optical filters, and other optical components while lowering cost, requiring minimal assembly, improve performance, and increase ease of customer handling.

### SUMMARY OF THE INVENTION

A calibration disk is disclosed for a rotary analytical device. The calibration disk includes a body with a main portion with a top surface, a bottom surface and a central rotational axis. A cylindrical extrusion extends upward from the top surface of the body and has an axis coincident with the central axis. The main portion substantially surrounds the cylindrical extrusion and includes a flat planar portion that extends radially outward from the cylindrical extrusion. The planar portion lies along a plane that is orthogonal to the central rotational axis. The cylindrical extrusion has a top surface and a sidewall surrounding an open interior cavity. A central opening is formed in the top surface of the cylindrical extrusion providing access to the interior cavity. The central opening is configured to mate with a spindle of the rotary analytical device, one method uses a non-circular shape configured to mate with a complimentary shape on a the spindle. A plurality of attenuation zones are formed in the body and spaced around the cylindrical extrusion. At least some of the attenuation zones include at least one aperture extending through the body from the top surface to the bottom surface. The apertures are located at a common radial position about the central axis. The apertures have a radial width and an circumferential length extending in the circumferential direction about the central axis. At least two of the apertures have a different radial width or axial length.

In some embodiments, the circumference of the central opening includes a plurality of flexible flanges.

The attenuation zones are optionally equally sized and evenly spaced about the circumference of the disk.

The attenuation zones may be separated from one another by thin dividers or stiffeners that extend radially outward from the base of the extrusion and project unidirectionally upward from the top surface of the body.

The attenuation zones preferably include at least one reference zone that includes a continuously flat top surface and does not include an aperture.

The apertures are preferably all positioned at a radial distance from the center of rotation that corresponds to the radial location of the centers of the LEDS and photoelectric transducers of the analytical device from the spindle; and each aperture is centered within a corresponding attenuation zone.

The apertures may be elongated in the circumferential direction such that each aperture's circumferential length is larger than its radial width.

In an embodiment, the aperture in a corresponding attenuation zone incrementally increases in circumferential length and radial width relative to the circumferential length and radial width in the preceding attenuation zone.

In an embodiment, the aperture in at least one of the attenuation zones incrementally increases in circumferential length and radial width relative to the circumferential length and radial width in another of the attenuation zones.

In one embodiment, the apertures in multiple attenuation zones have the same circumferential length and radial width.

A method of calibrating a rotary analytical device is also disclosed. The method includes the steps of:
providing a calibration disk;
providing a rotary analytical device including a housing with a cavity formed therein, the cavity having a bottom wall, and at least one side wall, a spindle protrudes substantially upward into the cavity and rotates about an axis by means of a motor, a cover is attached to the housing for covering an open top of the cavity, at least one light source arranged in either the cover or the bottom wall and directs a beam of light through the cavity to at least one light photometer mounted on the cover or the bottom wall;
placing the calibration disk on the spindle and closing the cover;
activating the motor to cause the spindle and calibration disk to rotate and the at least one light source to activate;
receiving light at the at least one photometer from the light source as it passes through the at least two apertures, wherein the light intensity received varies based on the circumferential length and radial width of the apertures;
determining the difference in light intensity between the apertures; and
correcting the measured optical readings to correspond with the output of a predetermined baseline absorbance reading.

The method may include readings for apertures having similar circumferential lengths and radial widths being averaged together to create one measured reading value for the corresponding aperture.

The foregoing and other features of the invention and advantages of the present invention will become more apparent in light of the following detailed description of the preferred embodiments, as illustrated in the accompanying drawings. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

The above and other aspects, features, and advantages of the present invention may be more apparent from the following more particular description of embodiments thereof, presented in conjunction with the following drawings. In the drawings:

FIG. 1 is a top view of the calibration disk.

FIGS. 1A, 1B, 1C, and 1D are details of different apertures on the calibration disk.

FIG. 2 is a bottom view of the calibration disk.

FIG. 3 is a cross-sectional view detailing the inside of the calibration disk.

FIG. 4 is an exemplary graphical representation of the relationship between absorbance versus known analyte concentrations, as known in the prior art.

FIG. 5 is an exemplary graphical representation of the relationship between absorbance versus known degrees of gray within film filters, as known in the prior art.

FIG. 6 is an exemplary graphical representation of the relationship between absorbance versus aperture size for ideal and random meters with exemplary optical calibration corrections, as disclosed in the present invention.

### DETAILED DESCRIPTION OF THE PREFERRED EMBODIMENTS

A better understanding of various features and advantages of the present methods and devices may be obtained by reference to the following detailed description of illustrative embodiments of the invention and accompanying drawings. Although these drawings depict embodiments of the contemplated methods and devices, they should not be construed as foreclosing alternative or equivalent embodiments apparent to those of ordinary skill in the subject art.

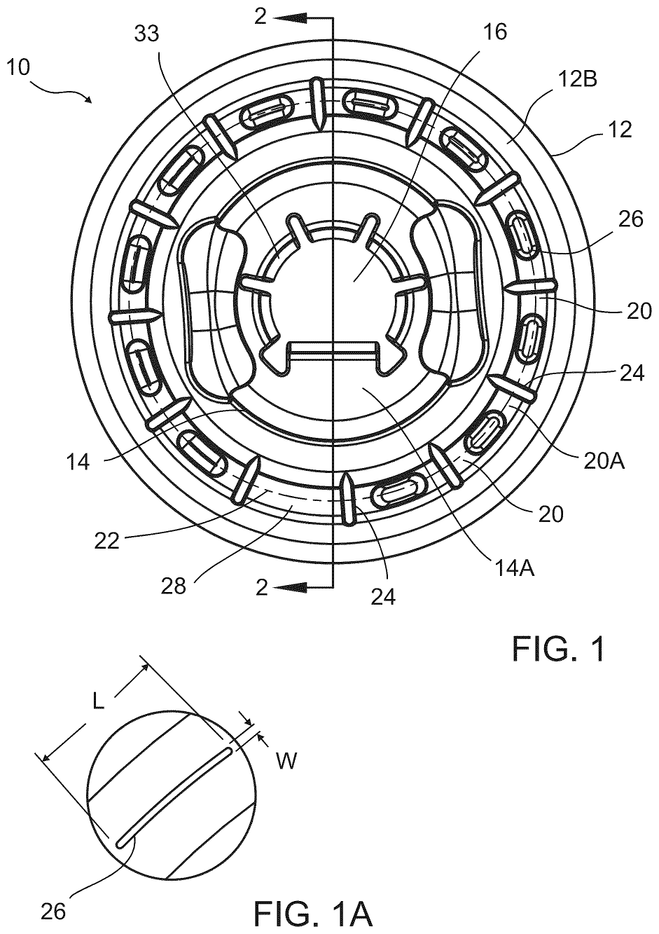

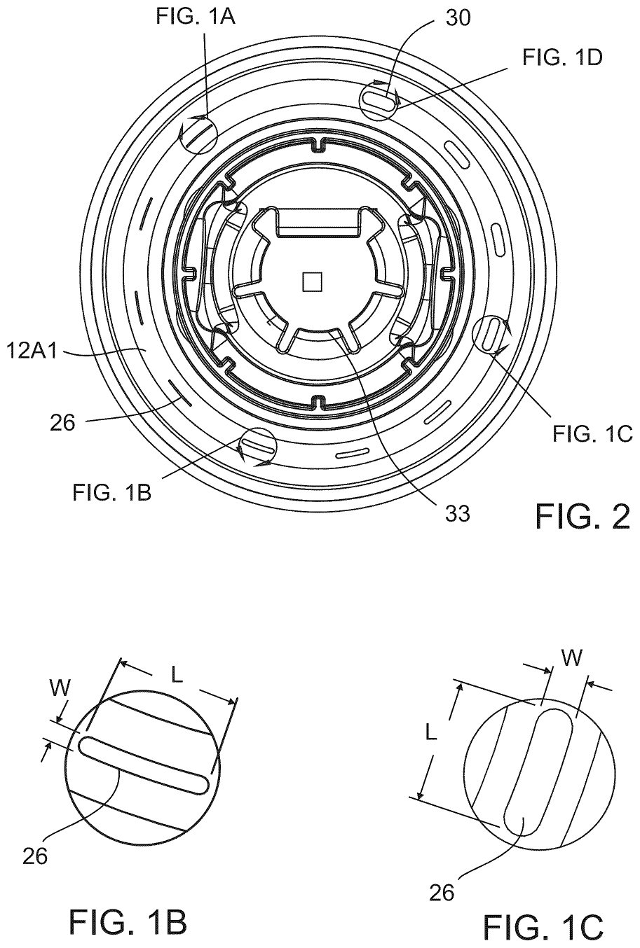

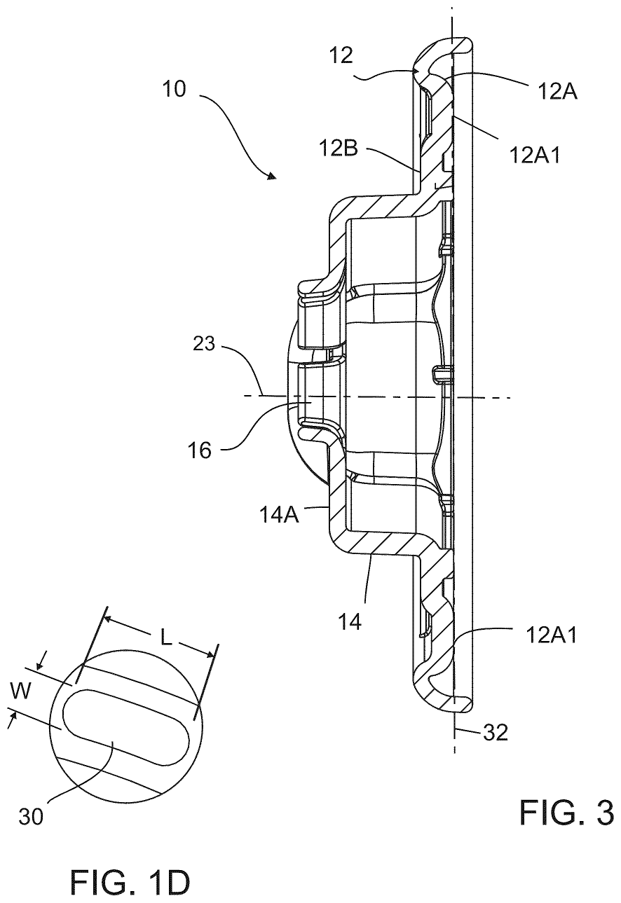

Referring to FIGS. 1 and 3, one form of the calibration disk, indicated generally by the reference number 10, comprises a single molded body with a main portion 12 that comprises a bottom surface 12A and a top surface 12B. A cylindrical extrusion 14 extends upward from the top surface 12B of the main portion 12 and is configured to engage with a rotary analytical device's spindle when mounted during use. The bottom surface 12A may include a, preferably annular, flat section 12A1 that is generally parallel to or lies on a planar reference surface 32. The calibration disk 10 may be made from an opaque material to limit and absorb stray light from the LEDs. Calibration disk 10 may include a central opening 16 through a top surface 14A of the cylindrical extrusion 14 that comprises a plurality of flexible flanges 33 to create a secure connection with the spindle. The central opening 16 is preferably D-shaped so that the calibration disk 10 may be configured to engage with a flat edge on the spindle. In certain embodiments of rotary analytical devices, since the spindle is calibrated to the rotary encoder mounted in the analytical device, when the disk 10 is mounted on the spindle, the orientation of the disk 10 relative to a rotary encoder in the analytical device can be determined. In other embodiments, the central opening 16 may be any suitable noncircular shape, provided that the central opening shape is configured to mate with a complimentary spindle shape and uniquely orients the disk on the spindle.

Referring to FIG. 1, showing a top view of the disk 10, the top surface 12B of the main portion 12 includes a plurality of attenuation zones 20 that are located around the cylindrical extrusion 14 and preferably correspond to the location of the analysis chambers in the analytical cartridges. The zones 20 are preferably separated from one another by thin dividers or stiffeners 24 that extend radially outward from the base of extrusion 14 past the zones 20 and project unidirectionally upward from top surface 12B. The dividers 24 assist in maintaining the overall structural stiffness of the disk 10 to avoid warping, bending, or any other major deviations relative to the bottom planar reference surface 32, all of which may compromise optical readings. The zones 20 are preferably equally sized and evenly spaced about the circumference of the disk, although that is not necessary in the present invention. The zones 20 are located about the circumference of a theoretical circle 22 with a center axis coincident with an axis of rotation 23 of the disk. The radius of the theoretical circle 22 when mounted on the spindle of the analytical device preferably corresponds to the radial location of the centers of the LEDS and photoelectric transducers of the analytical device, and to the analysis chambers of the analytical cartridge when the cartridge is mounted on the spindle. The location, geometry, and number of zones 20 are determined by the location and geometry of the analysis chambers in the analytical cartridge. Though it is contemplated that the geometry and number of zones 20 may vary; in FIG. 1, there are 12 zones shown.

Each attenuation zone 20 includes a smooth, flat surface 20A as part of top surface 12B, and most of the zones include an associated aperture 26. Each aperture 26 is located circumferentially about circle 22 and preferably centered within its corresponding zone 20. As stated, the apertures 26 are present in almost every zone; however, there exists at least one reference zone 28 that does not include an aperture and, instead, includes only a continuously flat surface 20A, which may be utilized for rotary calibration. That is, the inclusion of a reference zone that does not include an aperture results in the photometer reading a large dark section which permits identification of the rotary position of the disk relative to the light sources.

As shown in FIGS. 1A through 1D, the apertures 26 are preferably elongated in the circumferential direction (i.e., have a slight curvature with an axis that lies along the circumference of the theoretical circle 22) and fully extend between top surface 12B and bottom surface 12A of the main portion 12 so as to define a hole therebetween. The apertures may be tapered from the top surface 12B to the bottom surface 12A to increase the strength of the mold feature that creates the aperture. The minimal aperture size is defined by the size on the bottom surface 12B. The apertures 26 have a plurality of sizes, where the “aperture size” is defined by both the circumferential length “L” and radial width “W” of the aperture.

Referring to reference zone 28 on the disk's bottom view in FIG. 2 and moving counterclockwise about the circumference of circle 22, each subsequent aperture 26 may incrementally increase in aperture size relative to the aperture size in the preceding zone, though a specific order for aperture sizes is not necessary and should not be construed as limiting the scope of the present invention to one skilled in the art. The largest-sized aperture is referred to as a full aperture 30, as seen in detail in FIG. 1D, and the other apertures are referenced to the full aperture 30 in any calibration calculations. In one embodiment, there are multiple apertures that have the same size. During use the readings from the apertures with the same size may be averaged so as to provide one reading for that particular set of apertures for use in calibration. For example, larger apertures may be less prone to deviations in reading. As such, it is contemplated that readings from two or three larger apertures 26 having the same size can be averaged. Whereas smaller apertures 26 are more prone to deviations in reading, hence, it may be desirable to have four apertures 26 of the same size and determine an average reading from those. It is contemplated that the order of the varying aperture sizes, as well as the relative sizes of each aperture 26, may differ from those shown in the figures. In one embodiment, there may be between two aperture sizes and eleven aperture sizes. It is also contemplated that the number of zones, as well as corresponding apertures, may vary from those shown in the figures. Preferably at least two different aperture sizes are used to determine and characterize a linear response in the photodetector, and at least three different aperture sizes are used to determine and characterize a nonlinear response in the photodetector. The shape and location of each aperture 26 may be designed to correspond with the shape of the analysis chambers within each cartridge on the rotary analytical device.

In use, the calibration disk 10 is placed over the spindle such that the spindle's flat side aligns with and engages the flat side of the calibration disk's central opening 16. The bottom surface 12A of the main portion 12 is positioned near the surface of the optical windows above the photodetectors near a bottom wall in the rotary analytical device. The orientation of the disk 10 relative to the spindle locates the apertures at the same radial distance from the spindle as the photodetectors. Once the calibration disk 10 is mounted, the apparatus lid is closed, and the analyzer is activated, either by a control on the analyzer itself or by a command signal from a computer or handheld device (such as a mobile phone). The motor rotates the spindle, which rotates the disk. Optical readings are dynamically taken to measure the amount of light that passes through each aperture 26 to the respective photodetector. The light may vary in intensity based on the attenuation of light resulting from the corresponding aperture size relative to that of a full aperture 30.

Mathematical algorithms may be used to correct the measured optical readings to correspond with the output of an ideal or average absorbance reading. This “ideal” reading may be based on the average reading across a mass quantity of produced rotary analytical devices and calibration disks. The measured optical readings are dynamically taken by the photodetectors during calibration and, as mentioned above, may be averaged together to create one measured reading value for each corresponding aperture size. The light transmittance is defined as the ratio of the measured optical reading to the reading of a full aperture 30 (i.e., if the transmittance is in units of percentage, the transmittance of a full aperture 30 would be 100%). The measured absorbance is calculated by negating the logarithm of the light transmittance to the base 10. The measured absorbance may be corrected to closely resemble that of ideal absorbance readings through calculations using slope-correction multipliers and offset corrections. The slope-correction multipliers and offset corrections may be calculated or adjusted manually to correct or calibrate the photometric output to match the ideal or average photometric output for a given aperture size. The algorithms may be implemented in software programming to facilitate automated calibration.

As described qualitatively above, the following process provides one method for providing calibration according to the present invention:
Step 100. Multiple readings are taken by the photometer:

$$reading = light A / D counts - dark A / D counts \qquad ( Eq . 1 )$$

where the readings or counts are averaged.
Step 110. Next the abs is calculated according to the following equation:

$$abs = - log * ( sample reading / blank reading ) \qquad ( Eq . 2 )$$

Step 120. abs is then corrected to account for slope and offset:

$$abs 1 = C 1 * abs + C 2 \qquad ( Eq . 3 )$$

where:
   C1 is a multiplier or slope correction for the absorbance,
   C2 is an offset correction,
   A/D counts are digital, or “raw,” counts used to quantify output,
   light counts is the raw count when the LEDs are on,
   dark counts is the raw count when the LEDs are off,
   abs is the calculated absorbance, and
   abs1 is the corrected or calibrated photometric output to the ideal or average photometer that is the reference photometer output.

It should be noted that the calculation in Step 110 uses a ratio of the sample to the blank which helps to minimize meter variation. A calculation that uses just the intensity of the sample reading to calculate the concentration of the analyte in the sample would also be work in the present invention.

The A/D counts are determined by connecting the photodetector's analog voltage output to an analog-to-digital (A/D) converter within a microprocessor or a stand-alone A/D converter, converting the analog response to digital values which can be used by a microprocessor. Light counts are used for the photometric measurements. Dark counts are used to correct for any noise in the electronic circuitry. These digital counts are used by the microprocessor as measured output values and calculate absorbance readings. C1 and C2 can be adjusted manually or calculated from the results of the calibration disk to correct absorbance readings.

The corrected absorbance values can be used to calculate analyte concentration values. For example, in one embodiment, once the calibration disk readings are determined, they can also be applied to the individual analyte readings from a cartridge during use to correct concentration readings (for example in ppm) of a specific reagent. The following is one procedure for using the results of the calibration disk readings:

$$ppm = K 0 + K 1 abs 1 + K 2 abs {1}^{2} + K 3 abs {1}^{3} + K 4 abs {1}^{4} \qquad ( Eq . 4 )$$

$$corrected ppm = ( C 3 * ppm ) + C 4 \qquad ( Eq . 5 )$$

It should be noted that the ppm reading does not have to be a polynomial. C3 and C4 are the reagent/analyte adjustable calibration constants. These are adjusted to the “correct” reading when calibrating with the calibration disk.

A calibration disk according to the present invention was used to determine applicable corrections for reading obtained using a rotary analytic device. The following are example results for use in correcting photometric readings, which are used to demonstrate the principle of optical calibration. It should be noted that the examples and data presented below are solely exemplary and not actual data from a calibration disk; therefore, they should not be construed as limiting the scope to those of skill in the subject art.

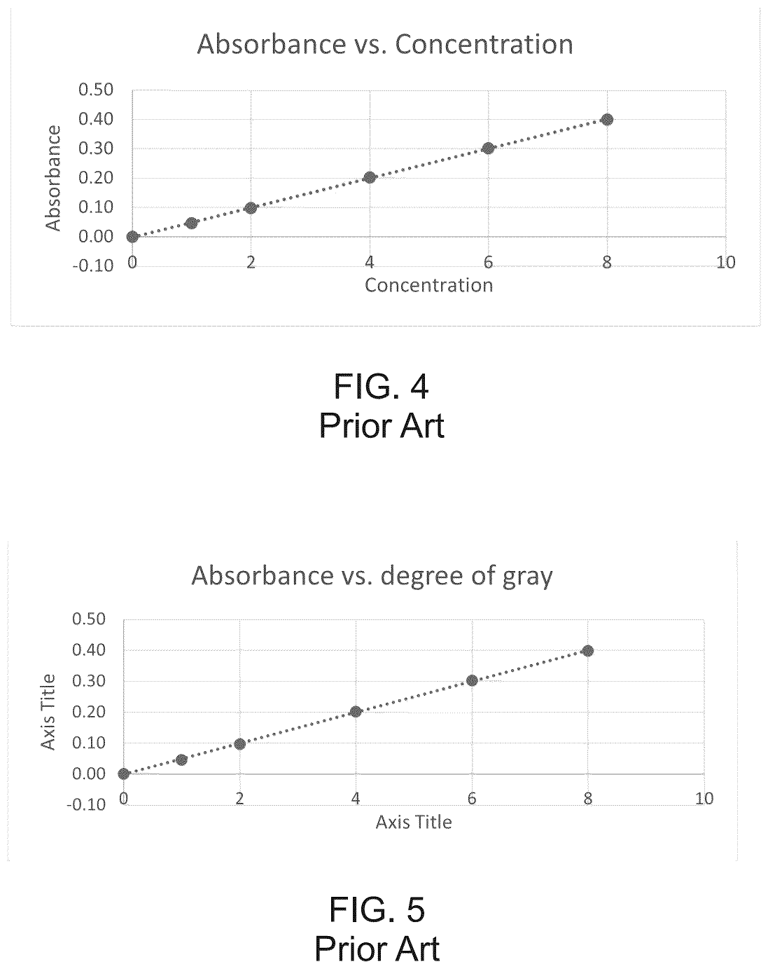

Table 1 shows the response (absorbance measurements) of an instrument to a series of reagent concentrations. This is the reagent calibration line. It depicts an optically calibrated meter. The absorbance versus concentration is graphical depicted in FIG. 4.

TABLE 1

| Optical calibration for reagents | | | |
|---|---|---|---|
| | light | ratio vs. | |
| concentration | intensity | 0 | absorbance |
| 0 | 100 | 1 | 0.00 |
| 1 | 90 | 0.9 | 0.05 |
| 2 | 80 | 0.8 | 0.10 |
| 4 | 63 | 0.63 | 0.20 |
| 6 | 50 | 0.5 | 0.30 |
| 8 | 40 | 0.4 | 0.40 |

Table 2 shows the response (absorbance measurements) of an instrument to a series of gray filters in accordance with the prior art. This is a filter calibration line. It depicts an optically calibrated meter. The absorbance vs. degree of gray is graphically depicted in FIG. 5.

TABLE 2

| Optical calibration for gray films | | | |
|---|---|---|---|
| degree of | light | ratio vs. | |
| gray | intensity | 0 | absorbance |
| 0 | 100 | 1 | 0.00 |
| 1 | 90 | 0.9 | 0.05 |
| 2 | 80 | 0.8 | 0.10 |
| 4 | 63 | 0.63 | 0.20 |
| 6 | 50 | 0.5 | 0.30 |
| 8 | 40 | 0.4 | 0.40 |

Table 3 illustrates the response (absorbance measurements) of an instrument to a series of aperture sizes. This is an aperture calibration line. It is depicts an ideal meter or an optically calibrated meter according to the present invention that includes a plurality of aperture sizes.

TABLE 3

| Ideal Meter | | | |
|---|---|---|---|
| | light | ratio vs. | |
| aperture size | intensity | 0 | absorbance |
| 10 | 100 | 1 | 0.00 |
| 9 | 90 | 0.9 | 0.05 |
| 8 | 80 | 0.8 | 0.10 |
| 6 | 63 | 0.63 | 0.20 |
| 4 | 50 | 0.5 | 0.30 |
| 2 | 40 | 0.4 | 0.40 |

Table 4 shows the response (absorbance measurements) of an instrument to a series of aperture sizes. This is the aperture calibration line. It depicts a uncalibrated meter using a rotary optical measuring device according to the present invention that includes a plurality of aperture sizes.

TABLE 4

| Random Meter | | | |
|---|---|---|---|
| | light | ratio vs. | |
| aperture size | intensity | 0 | absorbance |
| 10 | 100 | 1 | 0.00 |
| 9 | 88 | 0.88 | 0.06 |
| 8 | 76 | 0.76 | 0.12 |
| 6 | 56 | 0.56 | 0.25 |
| 4 | 43 | 0.43 | 0.37 |
| 2 | 35 | 0.35 | 0.46 |

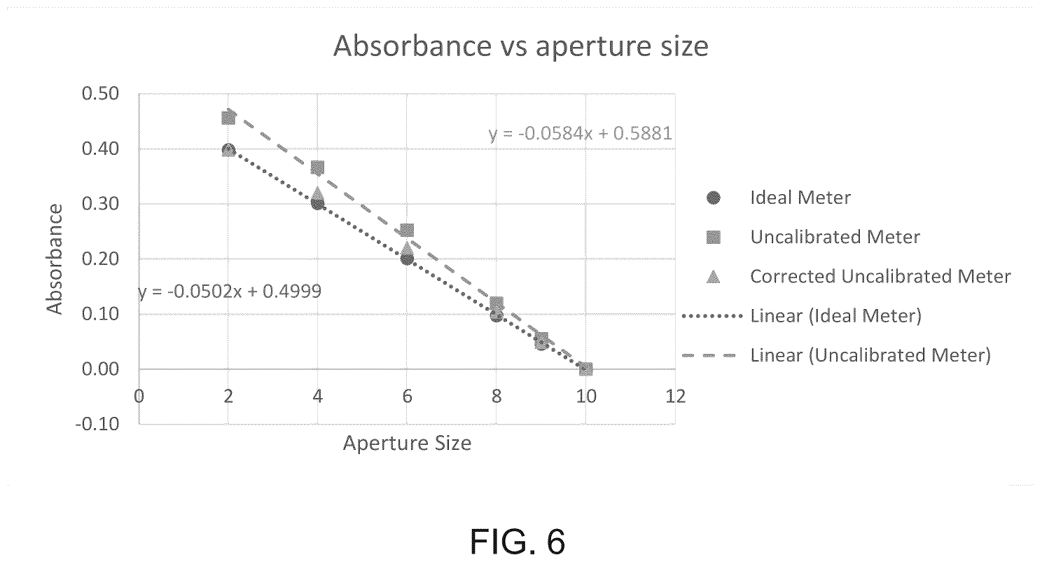

Table 5 illustrates an exemplary calculation or calibration correction according to the present invention to calibrate an uncalibrated meter to an ideal meter (abs1). The results of the calibration correction are show in FIG. 6.

TABLE 5

| Corrected Random Meter | | | | | | |
|---|---|---|---|---|---|---|
| aperture | light | ratio vs. | | | | |
| size | intensity | 0 | absorbance | C1 | C2 | abs1 |
| 10 | 100 | 1 | 0.00 | 0.87 | 0 | 0.00 |
| 9 | 88 | 0.88 | 0.06 | 0.87 | 0 | 0.05 |
| 8 | 76 | 0.76 | 0.12 | 0.87 | 0 | 0.10 |
| 6 | 56 | 0.56 | 0.25 | 0.87 | 0 | 0.22 |
| 4 | 43 | 0.43 | 0.37 | 0.87 | 0 | 0.32 |
| 2 | 35 | 0.35 | 0.46 | 0.87 | 0 | 0.40 |

The calibration methods known in the arts, such as the methods mentioned using gray film filters or known concentrations of analytes, requires skilled analysts to manufacture the filters or prepare the solutions, respectively. In both methods, skilled analysts and expensive costs to manufacture are required. The method of optical calibration using the calibration disk 10 comprising apertures 26 with a plurality of aperture sizes as disclosed herein is a single, moldable device that does not require a skilled analyst to perform such a calibration. The calibration disk 10 is also low cost, easy to use for users unskilled in the arts, and has a more controlled manufacturing process.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The particular implementations shown and described herein are illustrative examples of the invention and are not intended to otherwise limit the scope of the invention in any way. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

Terms such as “about” or “approximately”, unless otherwise defined or restricted in the specification, should be understood to define a variance of plus or minus 5%-10% to the numerical term referred to.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed. The various embodiments and elements can be interchanged or combined in any suitable manner as necessary.

The use of directions, such as forward, rearward, top and bottom, upper and lower are with reference to the embodiments shown in the drawings and, thus, should not be taken as restrictive. Reversing or flipping the embodiments in the drawings would, of course, result in consistent reversal or flipping of the terminology.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalent.

What is claimed is:

1. A calibration disk for a rotary analytical device comprising:
a body with a main portion with a top surface, a bottom surface and a central rotational axis, and a cylindrical extrusion extending upward from the top surface of the body and having an axis coincident with the central axis, the main portion substantially surrounds the cylindrical extrusion and includes a flat planar portion that extends radially outward from the cylindrical extrusion, the planar portion lying along a plane that is orthogonal to the central rotational axis, the cylindrical extrusion having a top surface and a sidewall surrounding an open interior cavity, a central opening is formed in the top surface of the cylindrical extrusion providing access to the interior cavity, the central opening configured to engage with a spindle of the rotary analytical device; and
a plurality of attenuation zones formed in the body and spaced around the cylindrical extrusion, at least some of the attenuation zones including at least one aperture extending through the body from the top surface to the bottom surface, the apertures being located at a common radial position about the central axis, the apertures having a radial width and an circumferential length extending in the circumferential direction about the central axis, and wherein at least two of the apertures have a different radial width or axial length on the bottom surface from one another.

2. The calibration disk of claim 1 wherein the circumference of the central opening includes a plurality of flexible flanges.

3. The calibration disk of claim 1, wherein the attenuation zones are equally sized and evenly spaced about the circumference of the disk.

4. The calibration disk of claim 3, wherein the attenuation zones are separated from one another by thin dividers or stiffeners that extend radially outward from the base of the extrusion and project unidirectionally upward from the top surface of the body.

5. The calibration disk of claim 1, wherein at least one of the attenuation zones is a reference zone that includes a continuously flat top surface and does not include an aperture.

6. The calibration disk of claim 5, wherein the apertures are all positioned at a radial distance from the center of rotation that corresponds to the radial location of the centers of the LEDS and photoelectric transducers of the analytical device from the spindle; and wherein each aperture is centered within a corresponding attenuation zone.

7. The calibration disk of claim 6, wherein the apertures are elongated in the circumferential direction such that each aperture's circumferential length is larger than its radial width.

8. The calibration disk of claim 7, wherein the aperture in a corresponding attenuation zone incrementally increases in circumferential length and radial width relative to the circumferential length and radial width in the preceding attenuation zone.

9. The calibration disk of claim 7, wherein the aperture in at least one of the attenuation zones incrementally increases in circumferential length and radial width relative to the circumferential length and radial width in another of the attenuation zones.

10. The calibration disk of claim 9, wherein the apertures in multiple attenuation zones have the same circumferential length and radial width.

11. A calibration disk for a rotary analytical device comprising:
a body with a main portion with a top surface, a bottom surface and a central rotational axis, and a cylindrical extrusion extending upward from the top surface of the body and having an axis coincident with the central axis, the main portion substantially surrounds the cylindrical extrusion and includes a flat planar portion that extends radially outward from the cylindrical extrusion, the planar portion lying along a plane that is orthogonal to the central rotational axis, the cylindrical extrusion having a top surface and a sidewall surrounding an open interior cavity, a central opening is formed in the top surface of the cylindrical extrusion providing access to the interior cavity, the central opening configured to engage with a spindle of the rotary analytical device and orient the body at a rotational position relative to the spindle;
a plurality of attenuation zones formed in the body and spaced around the cylindrical extrusion, at least some of the attenuation zones including at least one aperture extending through the body from the top surface to the bottom surface, the apertures being located at a common radial position about the central axis, the apertures having a radial width and an circumferential length extending in the circumferential direction about the central axis, and wherein at least two of the apertures have a different radial width or axial length on the bottom surface from one another, at least one of the attenuation zones is a reference zone that includes a continuously flat top surface and does not include an aperture, and wherein the apertures are all positioned at a radial distance from the center of rotation that corresponds to the radial location of the centers of the LEDS and photoelectric transducers of the analytical device from the spindle.

12. The calibration disk of claim 11, wherein the apertures each taper from the top surface to the bottom surface in at least one of its radial width or its axial length.

13. The calibration disk of claim 11, wherein the attenuation zones are separated from one another by thin dividers or stiffeners that extend radially outward from the base of the extrusion and project unidirectionally upward from the top surface of the body.

14. The calibration disk of claim 11, wherein each aperture is centered within a corresponding attenuation zone.

15. The calibration disk of claim 14, wherein the apertures are elongated in the circumferential direction such that each aperture's circumferential length is larger than its radial width.

16. The calibration disk of claim 15, wherein the aperture in a corresponding attenuation zone incrementally increases in circumferential length and radial width relative to the circumferential length and radial width in the preceding attenuation zone.

17. The calibration disk of claim 15, wherein the aperture in at least one of the attenuation zones incrementally increases in circumferential length and radial width relative to the circumferential length and radial width in another of the attenuation zones.

18. The calibration disk of claim 17, wherein the apertures in multiple attenuation zones have the same circumferential length and radial width.

19. A method of calibrating a rotary analytical device, the method comprising the steps of:
providing a calibration disk according to claim 1;
providing a rotary analytical device including a housing with a cavity formed therein, the cavity having a bottom wall, and at least one side wall, a spindle protrudes into the cavity and rotates about an axis by means of a motor, a cover is attached to the housing for covering an open top of the cavity, at least one light source arranged in one of the cover or the bottom wall and directs a beam of light through the cavity to at least one light photometer mounted in the other of the cover or the bottom wall;
placing the calibration disk on the spindle and closing the cover;
activating the motor to cause the spindle and calibration disk to rotate and the at least one light source to activate;
receiving light at the at least one photometer from the light source as it passes through the at least two apertures, wherein the light intensity received varies based on the circumferential length and radial width of the apertures;
determining the difference in light intensity between the apertures; and
correcting the measured optical readings to correspond with the output of a predetermined baseline absorbance reading.

20. The method of calibrating a rotary analytical device according to claim 19, wherein readings for apertures having similar circumferential lengths and radial widths are averaged together to create one measured reading value for the corresponding aperture.
